(19) United States
(12) Patent Application Publication
(10) Pub. No.: US 2011/0270929 A1
(43) Pub. Date: Nov. 3, 2011

(54) SYSTEMS AND METHODS FOR AUTOMATIC DETECTION AND COORDINATED DELIVERY OF BURDENSOME MEDIA CONTENT

(76) Inventors: Jeffrey Paul Harrang, Sammammish, WA (US); David B. Gibbons, Redmond, WA (US); C. James Judson, Seattle, WA (US)

(21) Appl. No.: 13/180,376

(22) Filed: Jul. 11, 2011

Related U.S. Application Data
(63) Continuation of application No. 12/562,254, filed on Sep. 18, 2009.
(60) Provisional application No. 61/098,159, filed on Sep. 18, 2008.

(51) Int. Cl. G06F 15/16

(52) U.S. Cl. 709/205

(57) ABSTRACT

A networked computing system that is capable of detecting and coordinating the distribution of burdensome media content. The networked computing system includes one or more sending devices, one or more receiving devices, and a data communications network capable of facilitating data communications amongst all networked computing devices. In response to a sending or receiving device generating a data transfer request, an automatic determination is made as to whether the media content is burdensome to a portion of the data communications network over which the media content is to be transferred. The automatic determination may be made by a sending device, a receiving device, or another local network resource (such as a gateway). The determining device may then coordinate the media content transfer based on characteristics of the media content and available network resources.

### CROSS REFERENCE TO RELATED APPLICATIONS

The present application is a continuation application of U.S. patent application Ser. No. 12/562,254, filed Sep. 18, 2009, which claims the benefit of U.S. Provisional Application No. 61/098,159, filed Sep. 18, 2008.

### TECHNICAL FIELD

The technical field of the invention generally relates to systems and methods for automatic detection and managed transfer of burdensome media content. The invention allows network service providers to protect portions of a data 15 communications network they are responsible for by facilitating coordinated deliveries for burdensome media content. In general, a coordinated delivery aligns problematic data transfers away from peak periods of network use.

### BACKGROUND ART

There are many different types of data communications networks today that can function independently (e.g., as Local Area Networks or LANs) or collectively as part of a group of interconnected networks (e.g., Wide Area Networks or WANs), such as the World Wide Web. Some of these networks include technologies that facilitate relatively fast, high data-rate transmissions (e.g., Fiber-optic, Cable, and Digital Subscriber Line (DSL) networks), while others can only facilitate much slower data-rate transmissions (e.g., cellular networks). Regardless of a network's type, topology, or employed technologies, most modern-day networks are susceptible to congestion or degradation due to high demand for transferring an alarming amount of media content between and amongst various network nodes.

As would be understood by those skilled in the art, network congestion generally refers to a state of data transfer overload (a load that burdens network capacity) between links in a data communications network. These heavy loads typically degrade a network's Quality of Service (QOS) and user's Quality of Experience (QOE). Some negative effects of network congestion, affecting QOS/QOE, may include queuing delay, packet loss, and the blocking of new and existing connections.

By way of example, widely popular Peer-to-Peer (P2P) file sharing networks that facilitate the transfer of huge data files (e.g., movies, TV programs, home video, software applications, video games, music, large volumes of text, etc.) over the Internet, such as those employing BitTorrent™ protocol, are estimated by some to account for approximately 27-55% of all Internet traffic (depending on geographical location) as of February 2009 (http://torrenffreak.com/bittorrent-stillking-of-p2p-traffic-090218/). A problem occurs when a significant number of users in P2P file sharing networks initiate unmanaged downloads and/or uploads of massive amounts of media content during peak network operating periods (during regular periods of high-use). Another recent example of congestion over a wireless network, can be seen in the inability of AT&T® wireless (a popular cellular service provider) to supply enough bandwidth to support new Apple™ I-phone™ technologies (e.g., new application software) that demand significant amounts of bandwidth to function (e.g., Streaming television, multimedia messaging (MMS), Tethering, etc.). Under these scenarios, network throughput over portions of a data communications network may be significantly reduced due to congestion caused by a relatively small number of network clientele consuming a disproportionate amount of network bandwidth (e.g., P2P or I-phone™ users transferring multiple, burdensome media content files).

Some media content data files of a significant size (e.g., files up to several Gigabytes large), that would generally be deemed burdensome to most networks, can take several hours and even days to download or upload to an end user's personal computing device over even high throughput data communications 60 networks (e.g., fiber-optic networks). Typically, burdensome media content is defined as being “burdensome”, “large”, and/or “problematic” in context with the capabilities (e.g., available network resources, such as free bandwidth) of the network or network segments over which the media content is to be delivered. For example, a media content that could be a manageable data file for transfer over a fiber-optic network could be too bulky for delivery over Cable, DSL, and/or most wireless networks (e.g., cellular networks). Similarly, a media content that could be manageable over one wireless network (e.g., a WiMAX™ or Wi-Fi™ network) might not be manageable over another wireless network (e.g., a cellular network). Additionally, a media content that could be manageable over one Cable network might not be manageable over another Cable network implementing similar network technologies, based purely on a determination of available network resources (e.g., one Cable network might experience much heavier loads over a desired transfer period compared with that of another Cable network).

Most network service providers want to supply their clientele with sufficient capacity in their portion of a larger network (e.g., a WAN) to be able to meet the peak data transfer demands of the service provider's collective users. When not enough capacity is available over a network or network segment, the aggregate QOE that network users encounter will often deteriorate. To remedy this lack of capacity, particularly during peak periods of operation, network service providers often commit to expensive, time-consuming technology additions and/or upgrades. These network enhancements serve to alleviate network congestion periods and to avoid persistent customer service calls from irritated customers. Under these scenarios, network service providers expend significant resources to protect their portion of a larger network.

Even though certain networks routinely experience periods of extreme congestion during peak data transfer periods (due to the daily, weekly, and yearly data transfer habits of a network's collective users), these same networks often experience periods of excess, wasted bandwidth during off-peak data transfer periods. Although, costly network enhancements can alleviate peak periods of congestion in most networks, these enhancements also create an increased surplus of wasted bandwidth during off-peak periods. It is therefore advantageous to consider new ways to utilize existing network resources in order to efficiently balance daily bandwidth usage over portions of a data communications network routinely experiencing network congestion, and to avoid unnecessarily expending service provider resources.

Accordingly, it would be desirable to have robust systems and methods that could align daily data transfer sessions for burdensome media content away from peak use periods towards periods of surplus network capacity. It would further be advantageous if these systems and methods could operate by automatically detecting, coordinating, and transferring burdensome media content to one or more end receiving device(s), such that a typical user would be unaware of how a particular network access provider chose to protect and allocate its network resources. As a result, an average network user's QOE should improve, while the underlying processes facilitating the improvement would remain transparent. It would also be desirable if these systems and methods could be deployed on the client side, by installing specialized data transfer management software within a user's LAN (e.g., on a client's personal computing device, or on local routers/switches or gateway devices that are also distributed within a LAN). This would allow an access provider to effectively distribute the task of managing burdensome media content to individual network users and/or to other LAN resources, such that independent network devices could operate to autonomously protect their respective portions of a larger network. It would be beneficial if these adaptive solutions could be deployed by a network service provider without requiring the supporting infrastructure of surrounding networks.

### DISCLOSURE OF INVENTION

This summary is provided to introduce (in a simplified form) a selection of concepts that are further described below in the Detailed Description. This summary is not intended to identify key features of the claimed subject matter, nor is it intended to be used as an aid in determining the scope of the claimed subject matter.

In overcoming the above disadvantages associated with existing media content delivery systems, the present invention discloses a networked computing system for automatically detecting and coordinating the distribution of burdensome media content away from peak network use periods, towards periods of surplus bandwidth. In accordance with an embodiment of the present invention, the networked computing system may include a first computing device, a second computing device, and a data communications network facilitating data communications amongst all computing devices within the networked computing system. In an embodiment, the first computing device may generate a data transfer request indicating media content to be transferred. In response to the data transfer request, an automatic determination is made as to whether the media content is burdensome to at least a portion of the data communications network over which the media content is to be transferred.

In accordance with another aspect of the invention the networked computing system may also include a third computing device that acts as a relay between the first computing device and the second computing device, such that a burdensome media content is transferred to the third computing device before being forwarded to an end receiving device.

In accordance with a further aspect of the invention, the first computing device may coordinate a download of the burdensome media content from at least the second computing device to the first computing device.

In accordance with another aspect of the invention, the first computing device may coordinate an upload of the burdensome media content from the first computing device to at least the second computing device.

In accordance with yet a further aspect of the invention, the automatic determination of whether the media content is burdensome may include an analysis of available network resources and an analysis of characteristics associated with the media content.

In accordance with a yet another aspect of the invention, the analysis of available network resources may include predicting available network bandwidth during distinct time periods based on past network performance.

In accordance with a further aspect of the invention, the analysis of the characteristics associated with the media content may include an analysis of the size and type of the media content to be transferred as well as available data transfer protocols.

In accordance with yet another aspect of the invention, is a computer-readable medium encoded with computer executable instructions, which when executed, performs a method including generating a data transfer request indicating a media content to be transferred, and automatically determining whether the media content is burdensome to at least a portion of a data communications network over which the media content is to be transferred, in response to the data transfer request.

In accordance with yet a further aspect of the invention, is a computer-implemented method including generating a data transfer request indicating a media content to be transferred, and automatically determining whether the media content is burdensome to at least a portion of a data communications network over which the media content is to be transferred, in response to the data transfer request.

### BRIEF DESCRIPTION OF DRAWINGS

Preferred and alternative examples of the present invention are described in detail below with reference to the following Figure drawings:

FIG. 1 illustrates a perspective view of a distribution system in accordance with an embodiment of the present invention;

FIG. 2 illustrates a block diagram of a Personal Computing Device in accordance with an embodiment of the present invention;

FIG. 3 illustrates a block diagram of a Media Content Provider in accordance with an embodiment of the present invention;

FIG. 4 illustrates a block diagram of a Access Provider Device in accordance with an embodiment of the present invention;

FIG. 5 illustrates a flow diagram depicting a managed data transfer process for a burdensome media content in accordance with an embodiment of the present invention;

FIG. 6 illustrates a flow diagram depicting managed data download and upload processes for burdensome media content in accordance with embodiments of the present invention;

FIG. 7 illustrates a flow diagram depicting a managed data download process for a burdensome media content in accordance with an embodiment of the present invention;

FIG. 8 illustrates a flow diagram depicting a managed data upload process for a burdensome media content in accordance with an embodiment of the present invention;

FIG. 9 illustrates a flow diagram depicting direct data download or upload processes for burdensome media content in accordance with embodiments of the present invention;

FIG. 10 illustrates an application interface displaying a Media Content Provider website and a browser-based application add-on component having a sub-menu that includes various media content process options in accordance with embodiments of the present invention; and

FIG. 11 illustrates an add-on application interface displaying the functionality of a media Download Manager in accordance an embodiment of the present invention.

### MODES FOR CARRYING OUT THE INVENTION

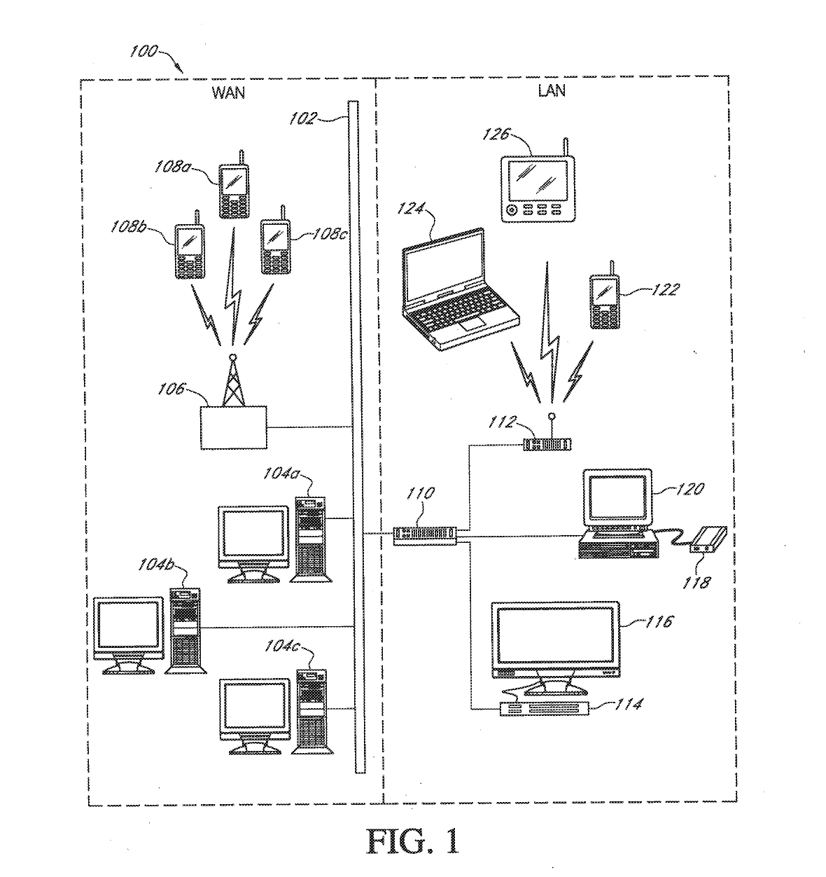

In accordance with an exemplary embodiment of the present invention, FIG. 1 illustrates a networked computing system 100 including various wireline and wireless computing devices that may be utilized to implement any of the media content detection/determination and coordinated delivery processes associated with various embodiments of the present invention. The networked computing system 100 may include, but is not limited to, a group of remote server devices 104a-c, any one of which may be associated with various Media Content Providers (MCPs) that can provide media content distribution services to various networked clientele or various Access Provider Devices (APDs, e.g., proxy servers) that can facilitate split, managed delivery of media content in accordance various coordinated delivery processes of the present invention; a data communications network 102 (including both Wide Area Network (WAN) and Local Area Network (LAN) portions); one or more remote client devices 108a-c (e.g., wireless communications devices) that may be connected to the data communications network 102 utilizing one or more wireless base station 106 or any common wireless or wireline network communications technology; one or more network gateway or switch devices 110 that can facilitate data communications processes within the LAN or between the LAN and the WAN of the data communications network 102; a television device 116 (e.g., a high definition LCD or Plasma television) that is connected to a multi-media device 114 (e.g., such as a cable television box, digital video recorder (DVR), Blu-ray™ player, and/or a digital video disk (DVD) player/recorder device); an external hard drive 118; a desktop computer 120; a wireless router 112 that may communicate with various wireless LAN devices using any common local wireless communications technology, such as Wi-Fi™ or unshielded twisted pair cable; a personal digital assistant (PDA) device 122; a wireless laptop computer 124; and a wireless media playback device 126 (e.g., a personal video player, an e-book device, or an ultra-portable computer or mini-computer device).

In various embodiments of the invention, any of the LAN connected devices (e.g., the network gateway device 110, wireless router 112, multi-media device 114, television 116, external hard drive 118, desktop computer 120, PDA device 122, wireless laptop computer 124, and the wireless media playback device 126) or the remote client devices 108a-c, may include local media transfer management functionality consistent with the automatic detection/determination and coordinated delivery processes of the present invention. As will be discussed further herein, the media transfer management functionality of the present invention may consist of download client and/or upload client processes that allow a media content transfer to be downloaded from one or more sending devices to a receiving device, or to be uploaded from a sending device to one or more receiving devices. Alternately, the media transfer management functionality of the present invention may also function with P2P file sharing networks, such as those employing BitTorrent™ protocol, that may facilitate the same media content file(s) being transferred from multiple sending computing devices to multiple receiving computing devices, simultaneously. Practical applications, employing these differing embodiments will be made apparent herein.

In an embodiment, the remote server devices 104a-c, the wireless base station 106, the remote client devices 108a-c, and any of the LAN connected devices (110, 112, 114, 116, 118, 120, 122, 124, and 126), may be configured to run any known operating system, including but not limited to, Microsoft Windows™, Mac OS™, Linux™, Unix™, or any common mobile operating system, including Symbian™, PaIm™, Windows Mobile™, Mobile Linux™, MXI™, etc. In an embodiment, the remote server devices 104a-c, the wireless base station 106 may employ any number of common server, desktop, laptop, and personal computing devices. In an embodiment, the remote client devices 108a-c and any of the LAN connected devices (110, 112, 114, 116, 118, 120, 122, 124, and 126) may include any combination of mobile computing devices (e.g., cellular phones, PDAs, eBooks, ultra-portable computers, personal music players, etc.), having wireless communications capabilities utilizing any common cellular data commutations protocol, such as GSM™, UMTS™, WiMAX™, Wi-Fi™, or LTE™ protocols.

In an embodiment, the WAN of the data communications network 102 may include, but is not limited to, any of the following communications technologies: optical fiber, coaxial cable, twisted pair cable, Ethernet cable, and power line cable, along with any wireless communication technology known in the art. In an embodiment, any of the remote server devices 104a-c, the wireless base station 106, the remote client devices 108a-c, and any of the LAN connected devices (110, 112, 114, 116, 118, 120, 122, 124, and 126), may include any standard computing software and hardware necessary for processing, storing, and communicating data amongst each other within the networked computing system 100. The computing hardware may include, but is not limited to, one or more processors, volatile and non-volatile memories, user interfaces, transcoders, and wireline and/or wireless communications transceivers.

In embodiment, any of the LAN connected devices (e.g., 110, 112, 114, 116, 118, 120, 122, 124, and 126) or the remote client devices 108a-c, may be configured to include one or more computer-readable media (e.g., any common volatile or non-volatile memory type) encoded with a set of computer readable instructions, which when executed, performs one or more data transfer and/or network resource management functions associated with any of the media content detection/determination and coordinated delivery processes of the present invention.

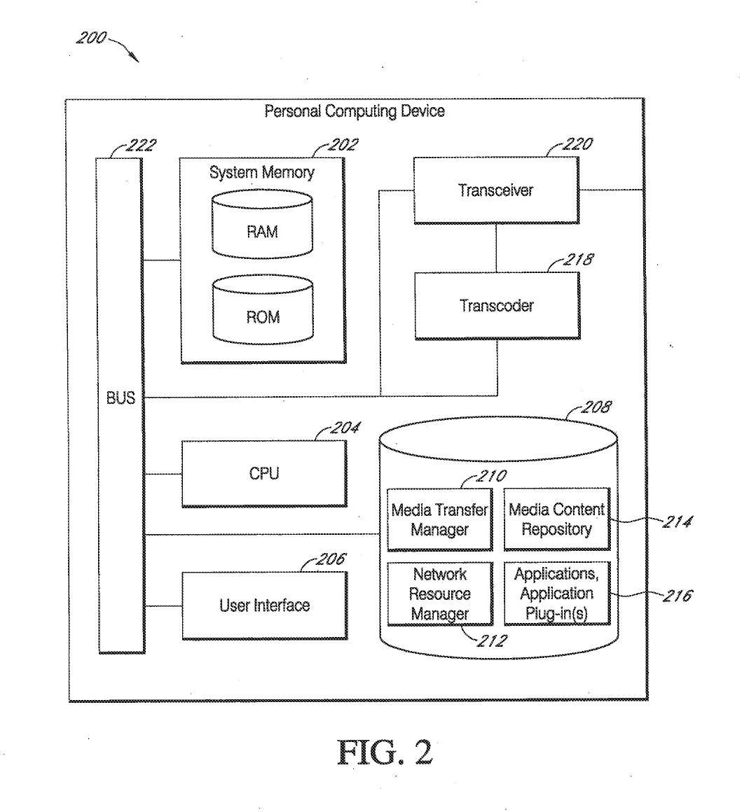

FIG. 2 shows a block diagram view of a PCD 200 that may be representative of any of the LAN connected personal computing devices (e.g., 114, 116, 118, 120, 122, 124, and 126) or the remote client devices 108a-c devices in FIG. 1. The PCD 200 may include, but is not limited to, one or more processor devices including a central processing unit (CPU) 204. In an embodiment, the CPU 204 may include an arithmetic logic unit (ALU, not shown) that performs arithmetic and logical operations and one or more control units (CUs, not shown) that extract instructions and stored content from memory and then executes and/or processes them, calling on the ALU when necessary during program execution. The CPU 204 is responsible for executing all computer programs stored on the PCD's 200 volatile (RAM) and nonvolatile (ROM) system memories 202 and 208. The PCD 200 may also include, but is not limited to, a user interface 206 that allows a user to interact with the PCD's software and hardware resources; a content database 208 that includes a media content transfer manager application 210, a network resource manager application 212, a media content repository 214, as well as various software applications and application plug-ins 216; a transcoder 218 for formatting media content; a transceiver 220 for transmitting and receiving data content (e.g., such as media content and media content Meta-Data) over the data communication network 102 of FIG. 1; and a system bus 222 that facilitates data communications amongst all the hardware resources of the PCD 200 (202, 204, 206, 208, 218, and 220).

In an embodiment, the media content transfer manager application 210 may include both download and upload client functionality that facilitates automatic detection/determination of burdensome media content transfer requests emanating from a client-side, coordination of direct or indirect (employing one or more intermediary data transfer agents) burdensome media content transfers, and Meta-Data generation for affecting an intermediary agent's role in a coordinated media content delivery process.

In an embodiment, the network resource manager application 212 may act independently or in conjunction with another PCD or intermediary transfer agent device to determine various available network resources (e.g., available bandwidth and communications protocols) over portions of a determined network link between media content sending and receiving device(s). In an embodiment, the media content repository 214 may include media content relating to various common media content, including, but not limited to: movies, TV programs, home video, software applications, video games, music, volumes of text, etc. Generally, existing media content in the repository 214 may be optionally reformatted (e.g., with the Transcoder 218) and uploaded to various end receiving devices. In an embodiment, the applications and application plug-ins 216 stored in the database 208 (e.g., web-browsers, browser plug-ins, email client applications, access provider utilities, etc.) may facilitate a user of the PCD 200 interacting with various MCPs and APDs over the data communications network 102 of FIG. 1. In an alternate embodiment, the PCD 200 may be connected to any external memory device (e.g., external hard drive 118 of FIG. 1), which may be capable of storing any of the utilities and repositories (210, 212, 214, and 216) of the content database 208. In an embodiment, the PCD 200 may be capable of loading and running any application or utility directly from an external memory 118 in real-time. In the context of the present application, “real-time” refers to process functionality that responds immediately, without unusual delay.

As discussed herein, the coordinated delivery processes of the present invention may include segmented data delivery processes, such as those discussed in commonly owned U.S. Pat. No. 7,500,010, titled “Adaptive File Delivery System and Method”, by Harrang et al., issued Mar. 3, 2009, incorporated herein by reference. Generally speaking, a coordinated delivery of a media content involves determining what media content data should be delivered to an end receiving device or devices over what network paths or segments during what periods of time, based on characteristics associated with a particular media content (e.g., file size, length, type, location of content source, number of network hops to content sources, content source network address, user authentication/authorization credentials or available transfer protocol (e.g., ftp, http, https, smtp, pop3, imap, p2p, etc.) and available network resources (e.g., including both current and predicted amounts of free bandwidth for at least a portion of a data communications network 102 over which a particular media content is to be transferred).

By way of example, if a burdensome 2-Gigabyte video file is requested to be transferred from a Node A to a Node B across a larger data communications network, a coordinated delivery process may automatically determine the most efficient transfer path and/or method between Node A and Node B to be over network portions X, Y, and Z. Part of the determination process may include consideration of the amount of free bandwidth presently on each of network portions X, Y, and Z, along with extrapolated or predicted amounts of free bandwidth on each of network portions X, Y, and Z, for time periods of anticipated network portion transfers (over periods of time that segments of the video file data may be transferred over each respective network portion), based on historic hourly, daily, monthly, and/or yearly bandwidth usage data. In various embodiments bandwidth usage data may have been statistically analyzed for average, mean, and/or median bandwidth usage values over select time periods and/or data-mined for recurrent bandwidth usage patterns over select time periods, for each network portion of interest. Further, real-time adjustment to a coordinated media content delivery may be made, based on continual network resource monitoring across network portions of interest (e.g., in the cases where any of network portions, X, Y, or Z, were experiencing and unusually high amount of traffic). In these cases, a coordinated delivery could be dynamically modified to account for unpredictable high usage of network resources in real-time.

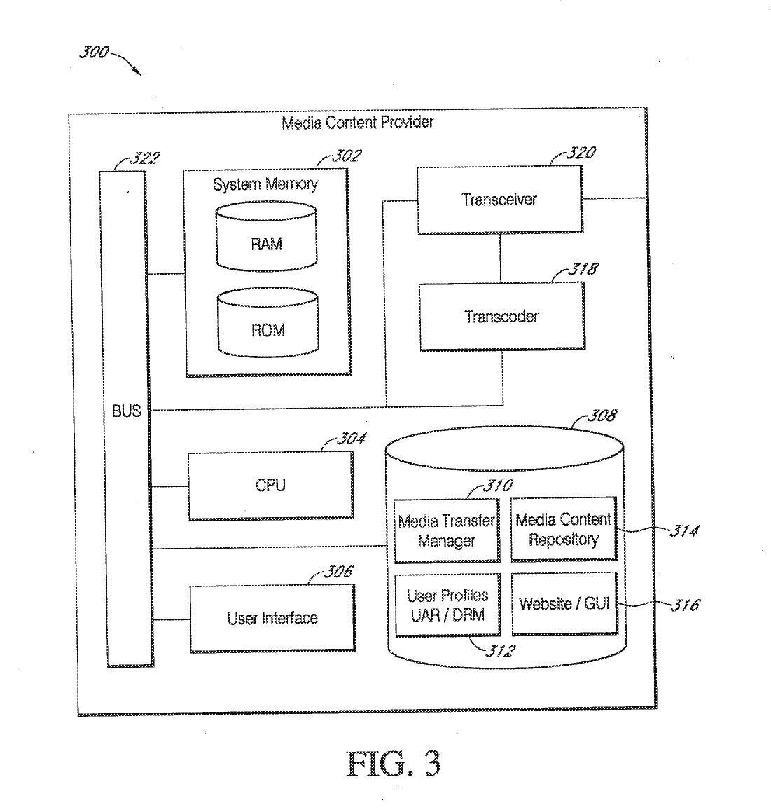

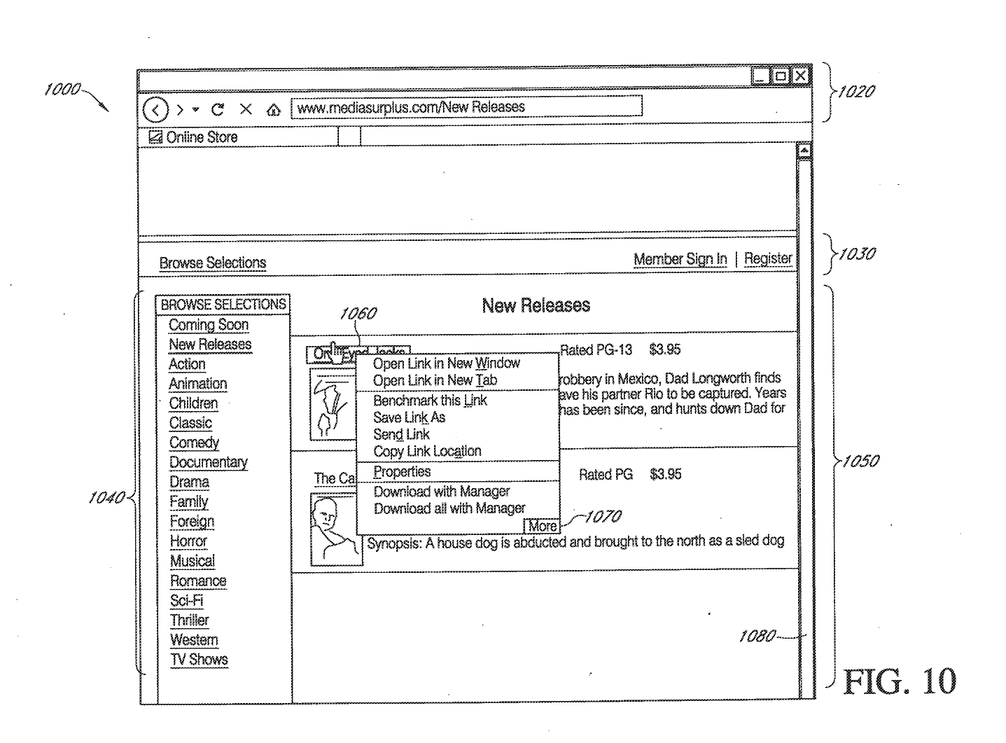

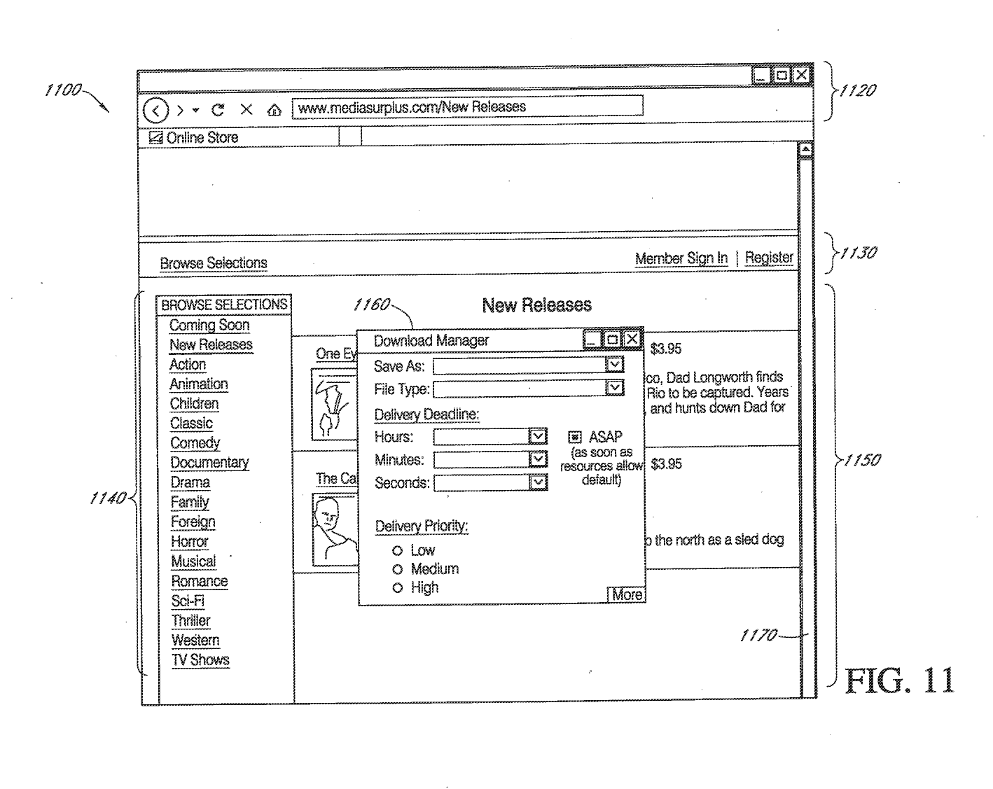

FIG. 3 shows a block diagram view of a MCP 300 that may be representative of any of the remote server devices 104a-c in FIG. 1. The MCP 300 may include, but is not limited to, one or more processor devices including a central processing unit (CPU) 304. The CPU 304 is generally responsible for executing all computer programs stored on the MCP's 300 volatile (RAM) and nonvolatile (ROM) system memories 302 and 308. The MCP 300 may also include, but is not limited to, a user interface 306 that allows a user/administrator to interact with the MCP's software and hardware resources; a content database 308 that includes a media content transfer manager application 310, a User Profile, User Access Rights (UAR), and Digital Rights Management (DRM) repository 312, a media content repository 314, as well as a hosted website (See e.g., MCP websites depicted FIGS. 10 and 11) including various graphical user interface (GUI) components (e.g., static html and dynamic components, such as java-based applications) that may facilitate a user making media content selections for purchase and download; a transcoder 318 for formatting deliverable media content; a transceiver 320 for transmitting and receiving data content (e.g., such as media content to be delivered to an end user device) over the data communication network 102 of FIG. 1; and a system bus 322 that facilitates data communications amongst all the hardware resources of the MCP 300 (302, 304, 306, 308, 318, and 320).

In an embodiment, the MCP's 300 media content transfer manager application 310 may help facilitate delivery of various media content data files (e.g., movies, TV programs, home video, software applications, video games, music, large volumes of text, etc., stored in the MCP's 300 media content repository 314) in response to various media content transfer requests. The media content transfer manager application 310 may also facilitate generation and delivery of various media content properties/characteristics, such as a particular media content's file size, length, type, location of content source, number of network hops to content sources, content source network address, user authentication/authorization credentials or available transfer protocol (e.g., ftp, http, https, smtp, pop3, imap, p2p, etc.). In accordance with various embodiments of the invention, the PCD's 200 media content transfer manager application 210 may query an MCP 300, storing a media content of interest, to determine these properties/characteristics so that it 210 can generate media content Meta-Data in order to facilitate coordinated media content delivery using an intermediary agent (e.g., such as an APD intermediary). In an embodiment, the MCP's 300 media content transfer manager application 310 may be responsible for transmitting a resident media file's properties/characteristics to a requesting PCD 200. In an embodiment, the MCP's 300 User Profile, User Access Rights (UAR), and Digital Rights Management (DRM) repository 312, may include information pertaining to secure identification of registered users (e.g., username and password information as well as contact and billing information), each registered user's rights to access various system resources and media content (e.g., access to various repositories and individual copyrighted media content, such as movies stored in the media content repository 314).

As would be understood by those skilled in the art, a DRM system is a system that protects copyrighted media content data that is circulated over the Internet or any other digital medium, by enabling secure distribution of proprietary media content data. Typically, a DRM system protects copyrighted media content data by either encrypting or digitally watermarking it in such a way that only an intended recipient can intercept, decrypt, and utilize the media content data. In this way, DRM technology can ensure that copyrighted media content will not be freely distributed to unauthorized users.

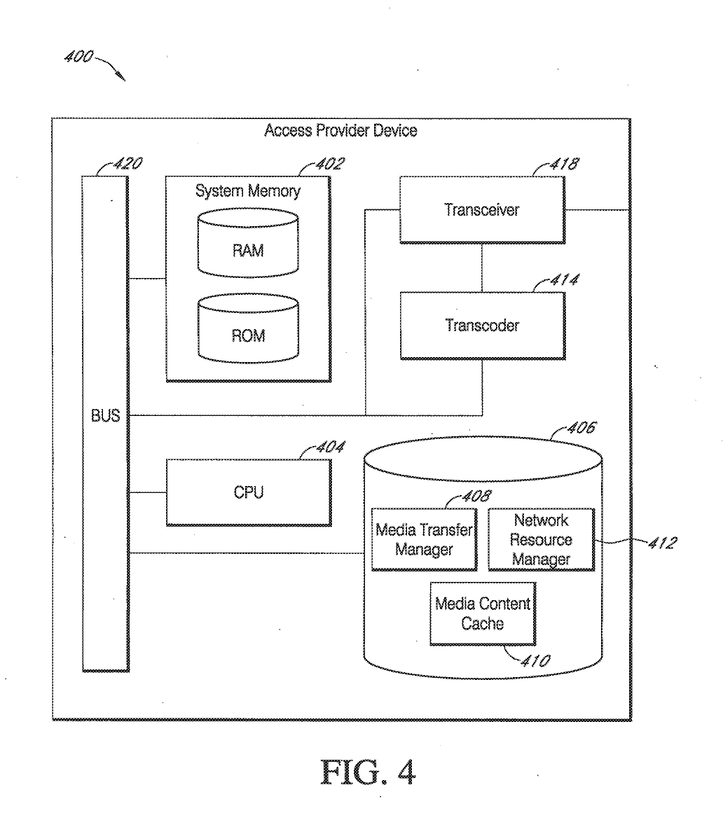

FIG. 4 shows a block diagram view of an APD 400 (such as a proxy delivery server) that may be representative of any of the remote server devices 104a-c in FIG. 1. The APD 400 may include, but is not limited to, one or more processor devices including a central processing unit (CPU) 404. The CPU 404 is generally responsible for executing all computer programs stored on the APD's 400 volatile (RAM) and nonvolatile (ROM) system memories 402 and 406. The APD 400 may also include, but is not limited to, a content database 406 that includes a media content transfer manager application 408, a media content cache memory 410, and network resource manager application 412; a transcoder 414 for reformatting deliverable media content; a transceiver 418 for transmitting and receiving data content (e.g., such as media content to be forwarded to one or more end user device(s)) over a data communication network, 102 of FIG. 1; and a system bus 420 that facilitates data communications amongst all the hardware resources of the APD 400 (402, 404, 406, 414, and 418).

In an embodiment, media content transfer manager application 408 of the APD 400 may be configured to receive coordinated media content transfer instructions and associated Meta-Data, for a particular media content to be transferred, utilizing the media content transfer manager application 210 of a PCD 200 (e.g., any of the LAN connected personal computing devices 114, 116, 118, 120, 122, 124, and 126 or the remote client devices 108a-c devices in FIG. 1). In response to received instructions from the PCD 200, the media content transfer manager application 408 of the APD 400 can dynamically manage a split delivery of a media content file from one or more sending devices (e.g., the MCP 300) to one or more receiving devices (e.g., the PCD 200). In general, the APD 400 may be configured to act as an intermediary transfer agent between various media content sending and receiving devices. In an embodiment, the media content cache memory 410 of the APD 400 may act as a temporary storage (e.g., a cache or buffer) for segments of a media content being transferred from sending to receiving devices.

In accordance with various embodiments of the present invention, a split delivery facilitated by the APD 400, might cache/buffer an entire media content to the cache memory 410 from a sending device and then forward partitioned segments (or copies of segments) of the media content to one or more receiving device(s) based on a received set of coordinated delivery instructions and currently available network resources between the APD 400 and the receiving device(s). In accordance with other embodiments of the present invention, the split delivery facilitated by the APD 400, might cache/buffer only segments of a media content to the cache memory 410 from a sending device, before simultaneously forwarding previously cached segments of the media content to one or more receiving device(s) based on a received set of coordinated delivery instructions and currently available network resources between the APD 400 and the receiving device(s). In the second scenario, the APD 400 actively buffers media content data to the cache memory 410 at the same time, previously cached segments of the media content data are being forwarded to designated end receiving devices. In either the full cache/transfer or actively buffering cache/transfer embodiments, a protected delivery typically only occurs between the APD 400 and the receiving device(s). A protected delivery, as discussed herein, generally refers to a data delivery process that prevents a network portion from entering a state of congestion by managing burdensome data transfers over that portion of the network so as to limit a data transfer load during peak operating periods. In practical situations, a network service provider may wish to protect all data communications links within its portion of a larger data communications network to ensure reliable QOS and QOE for its network clientele. In accordance with certain embodiments of the present invention, a networked computing system (e.g., networked computing systems 100 of FIG. 1) may include a chain of APDs 400 (e.g., Proxy Servers) that are interconnected to collectively facilitate managed data transfers of media content over select portions of a larger data communications network. In various embodiments, a media content delivery may occur by transferring a media content through multiple APD 400 devices to one or more end receiving device(s). In an embodiment, the chain of APDs 400 may facilitate a service provider selectively protecting individual network portions between media content sending and receiving devices, by utilizing one or more of the APDs 400 to affect coordinated data transfers within a networked computing system.

In an embodiment, the network resource manager application 412 of the APD 400 may determine various available network resources (e.g., free bandwidth) between portions of a network link between media content sending and receiving device(s). In an embodiment, the network resource manager application 412 of the APD 400 communicates with the network resource manager application 212 of the PCD 200 to determine available network resources between the APD 400 and the PCD 200. In this embodiment, the media content transfer manager application 210 of a PCD 200 may generate coordinated delivery instructions based at least partly on a determined state of available network resources between the APD 400 and the sending or receiving PCD 200 devices.

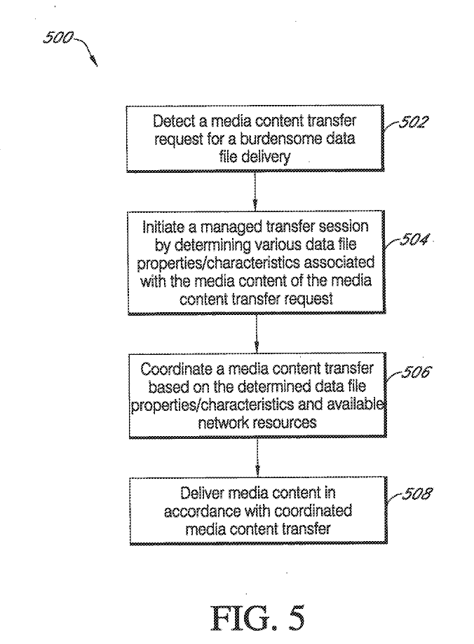

FIG. 5 illustrates a flow diagram for a managed data transfer process 500 for burdensome media content in accordance with an embodiment of the present invention. It should be understood that this process 500 could be executed using one or more computer executable programs stored on one or more computer-readable media located on any of the LAN connected devices (e.g., 110, 112, 114, 16, 118, 120, 122, 124, and 126) or the remote client devices 108a-c of FIG. 1. Further, collaborative processes associated with the managed data transfer 500 could be executed from one or more MCP 300 or APD 400 devices (e.g., represented by any of the remote server devices 104a-c). At block 502, a media content transfer request for a burdensome media content delivery is detected (e.g., in response to a media content download or upload request made utilizing a resident application on any of the LAN connected personal computing devices 114, 116, 118, 120, 122, 124, and 126, or any of the remote client devices 108a-c). Next, at block 504, a managed transfer session is initiated by determining various data file properties/characteristics associated with the media content of the media content transfer request. In an embodiment, these media file properties and characteristics may include, but are not limited to, items such as, file size, length, type, location of content source, number of network hops to content sources, content source network address, user authentication/authorization credentials or available transfer protocol (e.g., ftp, http, https, smtp, pop3, imap, p2p, etc.) At block 506, a media content transfer is coordinated based on the determined data file properties/characteristics for the media content and available network resources (e.g., free bandwidth for at least a portion of a data communications network over which the media content is to be transferred). At block 508, the requested media content is delivered to one or more receiving devices in accordance with the coordinated media content transfer.

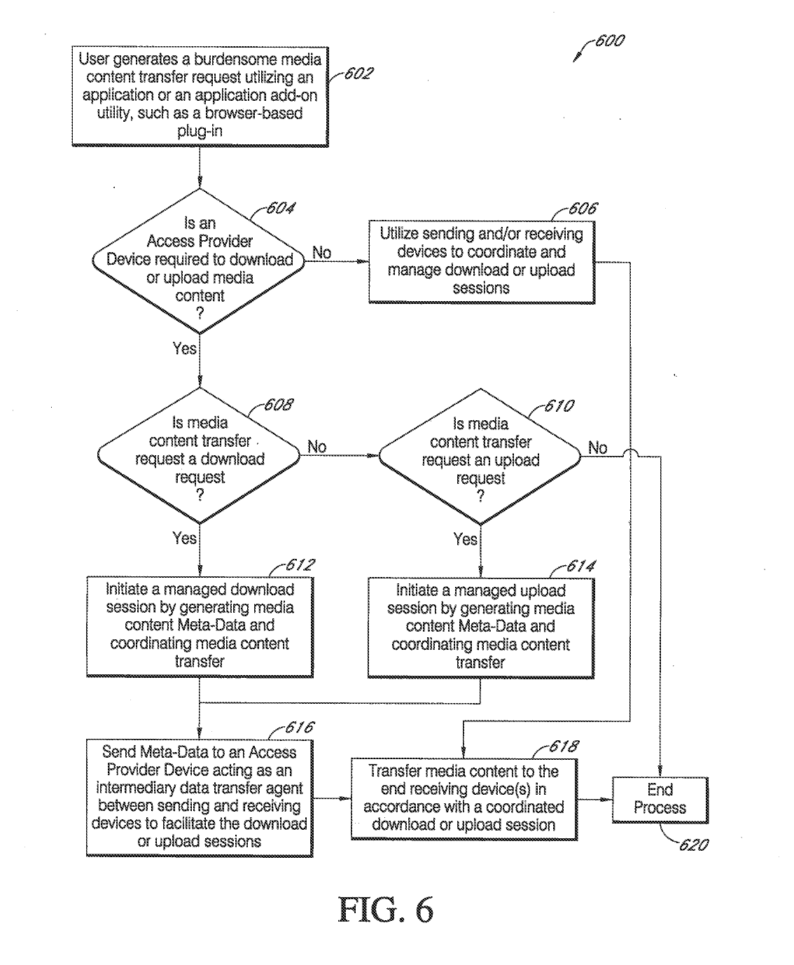

FIG. 6 illustrates a flow diagram for managed data download and upload processes 600 for burdensome media content delivery, in accordance with various embodiments of the present invention. It should be understood that these processes 600 could be executed using one or more computer executable programs stored on one or more computer-readable media located on any of the LAN connected devices (e.g., 110, 112, 114, 116, 118, 120, 122, 124, and 126) or the remote client devices 108a-c of FIG. 1. Further, collaborative processes associated with the download and upload processes 600 could be executed from one or more MCP 300 or APD 400 devices (e.g., represented by any of the remote server devices 104a-c). At block 602, a user (e.g., a user of a PCD 200) generates a burdensome media content transfer request utilizing an application or an application add-on utility, such as a browser based plug-in (e.g., an application or plug-in residing in the content database 208 of the PCD 200). Next, at decision block 604, it is determined if an APD 400 (e.g., a proxy server device) is required download or upload the media content. If an APD 400 is not required, then the process proceeds to block 606. At block 606, a sending or a receiving device is utilized to coordinate and manage either media content download or upload data transfer sessions associated with the burdensome media content transfer request; then the process proceeds to block 618.

However, if an APD 400 is required to download or upload media content, then the process proceeds to decision block 608, where it is determined if the burdensome media content transfer request is a download request. If the burdensome media content transfer request is a download request, then the process proceeds to block 612, where a managed download session is initiated by generating Meta-Data (generated Meta-Data may include data pertaining to file size, length, type, location of content source, number of network hops to content sources, content source network address, user authentication/authorization credentials or available transfer protocol (e.g., ftp, http, https, smtp, pop3, imap, 545 p2p, etc.) and coordinating a media content transfer session. However, if the burdensome media content transfer request is not a download request, the process proceeds to decision block 610, where it is determined if the burdensome media content transfer request is an upload request. If the burdensome media content transfer request is an upload request, the process proceeds to block 614, where a managed upload session is initiated by generating Meta-Data (generated Meta-Data may include data pertaining to file size, length, type, location of content source, number of network hops to content sources, content source network address, user authentication/authorization credentials or available transfer protocol (e.g., ftp, http, https, smtp, pop3, imap, p2p, etc.), and coordinating a media content transfer. However, if the burdensome media content transfer request is also not an upload request; the process ends at block 620.

After either a managed download or upload session is initiated at either of blocks 612 or 614, the generated Meta-Data is sent to an intermediary APD 400 to facilitate the download or upload sessions at block 616. Next at block 618, the media content set for download or upload is transferred to one or more end receiving device(s) in accordance with a coordinated download or upload session. In an embodiment, coordinated transfer instructions may either be included in the Meta-Data or may accompany the Meta-Data in the Meta-Data transfer process of block 616. After the media content is transferred to the end receiving device(s) at block 618, the process ends at block 620.

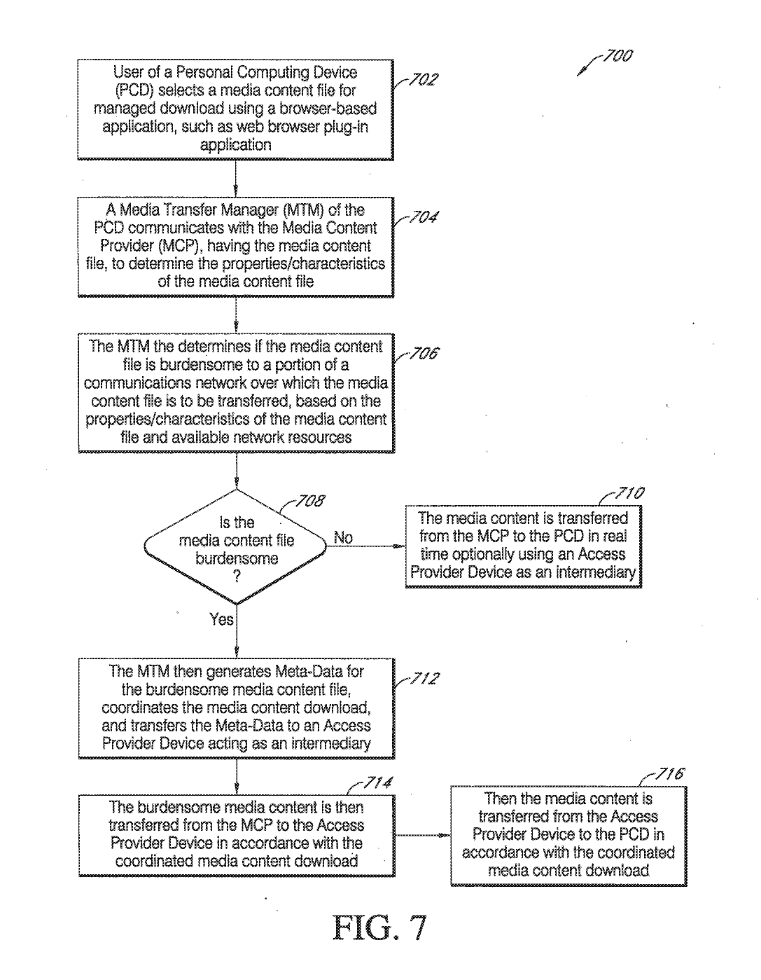

FIG. 7 illustrates a flow diagram for a managed data download process 700 of detected, burdensome media content in accordance with an embodiment of the present invention. It should be understood that download process 700 could be executed using one or more computer executable programs stored on one or more computer-readable media located on any of the LAN connected devices (e.g., 110, 112, 114, 116, 118, 120, 122, 124, and 126) or the remote client devices 108a-c of FIG. 1. Further, collaborative processes associated with the download 700 could be executed from one or more MCP 300 or APD 400 devices (e.g., represented by any of the remote server devices 104a-c). At block 702, a user of a PCD 200 (e.g., any of PCD devices 114, 116, 118, 120, 122, 124, 126, or 108a-c) selects a media content file for managed download using a browser-based application, such as a web-browser plug-in application. In embodiments, a user may use an existing application interface or a drop-down menu to select and initiate one or more download processes. Next, at block 704 a Media Transfer Manager (MTM, e.g., media content transfer manager 210) of the PCD 200 communicates with the MCP 300, having the media content file, to determine the properties/characteristics of the media content file (e.g., data pertaining to file size, length, type, location of content source, number of network hops to content sources, content source network address, user authentication/authorization credentials or available transfer protocol (e.g., ftp, http, https, smtp, pop3, imap, p2p, etc.). Then at block 706 the MTM of the PCD 200 determines if the media content file is burdensome to a portion of a communications network over which the media content file is to be delivered, based on the determined properties/characteristics associated with the media content file and various available network resources (e.g., current and predicted free bandwidth over portions of a data communications network over which the media content file is to be transferred).

Then, at decision block 708 if the media content file was determined to be burdensome (e.g., by comparing a determined file size with a threshold burdensome file size, etc.), the process proceeds to block 712, where the MTM generates Meta-Data pertaining to the burdensome media content file; coordinates the media content file download logistics; and transfers the Meta-Data to an APD 400, acting as an intermediary data transfer agent. In an embodiment, coordinated download instructions for the APD 400 may either be included in the Meta-Data content or may be included as a separate set of instructions in the Meta-Data transfer process of block 712. Next at block 714, the burdensome media content is transferred from the MCP 300 to the APD 400 in accordance with the coordinated media content download (this portion of the coordinated delivery may occur in real-time, as an unprotected, continuous data transfer). Finally, at block 716, the media content is transferred from the APD 400, to the PCD 200 in accordance with the coordinated media content download (this portion of the coordinated delivery may be protected by transferring media content during periods of surplus bandwidth). However, if at decision block 708 if the media content file was determined not to be burdensome, the process proceeds to block 710, where the media content is transferred from the MCP 300 to the PCD 200 in real-time (without unusual delay) optionally utilizing an APD 400 as an intermediary transfer agent device.

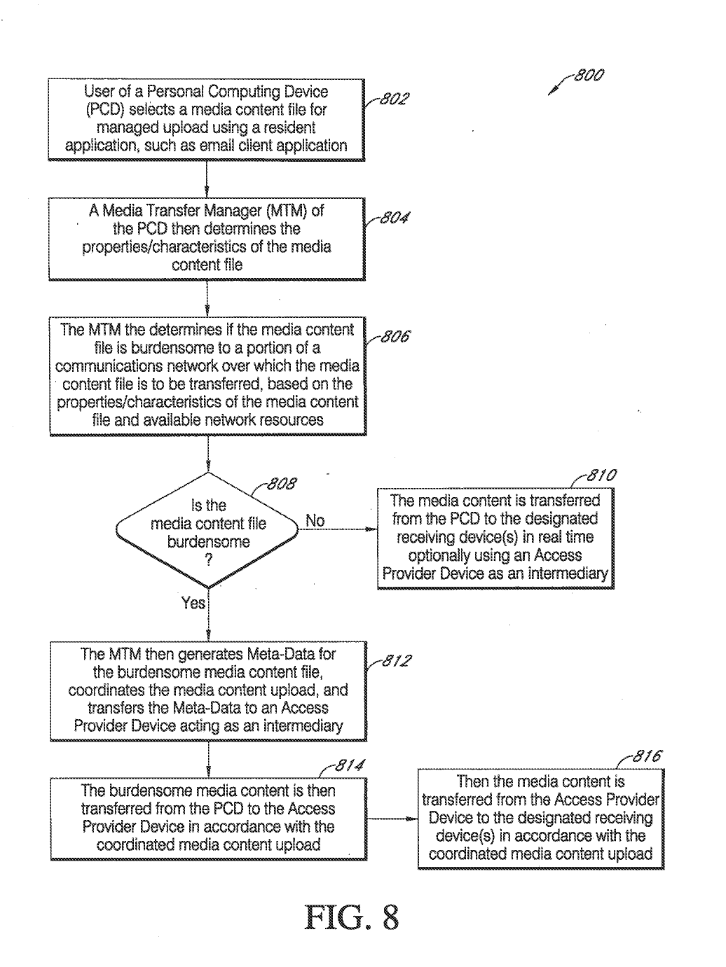

FIG. 8 illustrates a flow diagram for a managed data upload process 800 of detected, burdensome media content in accordance with an embodiment of the present invention. It should be understood that upload process 800 could be executed using one or more computer executable programs stored on one or more computer-readable media located on any of the LAN connected devices (e.g., 110, 112, 114, 116, 118, 120, 122, 124, and 126) or the remote client devices 108a-c of FIG. 1. Further, collaborative processes associated with the upload 800 could be executed from one or more MCP 300 or APD 400 devices (e.g., represented by any of the remote server devices 104a-c). At block 802, a user of a PCD 200 (e.g., any of PCD devices 114, 116, 118, 120, 122, 124, 126, or 108a-c) selects a media content file for managed upload using a resident application, such as an email client application. Next, at block 804 a Media Transfer Manager (MTM, e.g., media content transfer manager 210) determines the properties/characteristics of one or more media content files to be uploaded. Then at block 806, the MTM determines if the media content file is burdensome to a portion of a data communications network over which the media content file is to be delivered, based on the determined properties/characteristics associated with the media content file and various available network resources (e.g., current and predicted free bandwidth over portions of a data communications network over which the media content file is to be transferred).

Then, at decision block 808 if the media content file was determined to be burdensome, the process proceeds to block 812, where the MTM generates Meta-Data pertaining to the burdensome media content file; coordinates the media content file upload logistics; and transfers the Meta-Data to an APD 400, acting as an intermediary data transfer agent. In an embodiment, coordinated upload instructions for the APD 400 may either be included in the Meta-Data content or be included as a separate set of instructions in the Meta-Data transfer process of block 812. Next at block 814, the burdensome media content is transferred from the PCD 200 to the APD 400 in accordance with the coordinated media content upload (this portion of the coordinated delivery may be protected by transferring media content during periods of surplus bandwidth). Finally, at block 816, the media content is transferred from the APD 400 to the designated receiving devices in accordance with the coordinated media content upload (this portion of the coordinated delivery may occur in real-time, as an unprotected, continuous data transfer). However, if at decision block 808 the media content file was determined not to be burdensome, the process proceeds to block 810, where the media content is transferred from the PCD 200 to one or more designated receiving device(s) in real-time (without unusual delay), optionally utilizing an APD 400 as an intermediary transfer agent device.

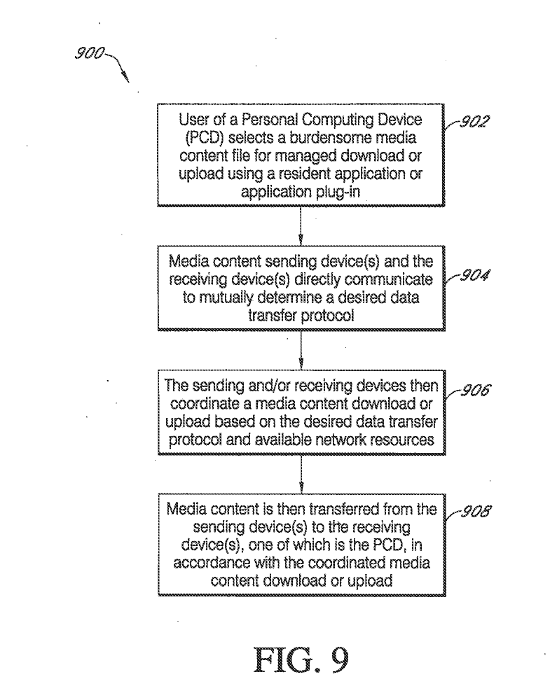

FIG. 9 illustrates a flow diagram for direct data download or upload processes 900 for burdensome media content in accordance with various embodiments of the present invention. It should be understood that the direct download or upload processes 900 could be executed using one or more computer executable programs stored on one or more computer-readable media located on any of the LAN connected devices (e.g., 110, 112, 114, 116, 118, 120, 122, 124, and 126) or the remote client devices 108a-c of FIG. 1. At block 902 a user of a PCD 200, selects a burdensome media content file for managed download or upload using a resident application or application plug-in. Next at block 904 one or more media content sending device(s) directly communicate with one another to mutually determine a desired data transfer protocol. Then at block 906, the sending and/or receiving devices coordinate a media content download or upload based on the desired data transfer protocol and available network resources. Finally, at block 908 the media content is transferred from one or more sending device(s) to one or more receiving device(s) (one of which is the PCD 200) in accordance with the coordinated media content download or upload.

FIG. 10 illustrates an application interface displaying a Media Content Provider website 1000 (more particularly a “New Releases” webpage of the MCP website 1000) and a browser-based application add-on component (e.g., a web browser with a plug-in application) having a drop-down sub-menu 1070 that includes various media content process options in accordance with embodiments of the present invention. In an embodiment, the MCP website 1000 could exist on any of the remote server devices 104-c, any one of which may be associated with a MCP 300 (e.g., the website/GUI application 316 of the MCP 200 content database 308). The MCP website 1000, may include, but is not limited to, a URL address bar 1020 having an HTTP website address for the webpage's location on the Internet (“http://www.mediasurplus.com/NewReleases”); a menu header 1030 having links to “Browse Selections” (as displayed), “Member Sign-In”, and “Register” website locations; a “Browse Selections” section 1040 including links to various multi-media genre (e.g., “New Releases”, “Drama”, “Action”, “Horror”, “Family”, etc.) that point to media content (e.g., movies) pertaining to particular media genre; a media content display section 1050 that facilitates the display of various media content (e.g., brief media content descriptions) in a selected genre (e.g., in the “New Releases” genre); a roll-over or right-click activated link 1060 to a drop-down sub-menu 1070, which includes several process options, including an option to download one or more selected media content with a Download Manager (e.g., operating as a plug-in application); and one or more scroll bars to facilitate viewing portions of the media content display section 1050 that do not naturally fit within in the website 1000 display area.

FIG. 11 illustrates an application interface displaying a view of an MCP website 1100 (a “New Releases” webpage) and a Download Manager add-on component (e.g., operating as a plug-in to a browser-based application) in accordance with embodiments of the present invention. In an embodiment, the MCP website 1100, may include, but is not limited to, a URL address bar 1120 having an HTTP website address; a menu header 1130; a “Browse Selections” section 1140; a media content display section 1150; a Download Manger application interface 1160 that includes a user interactive input area where a user can select various MCP download options; and one or more scroll bars 1170 that facilitate viewing additional portions of the media content display section 1150.

In an embodiment, the Download Manger application interface 1160 may include a “Save As” selection area where a user (e.g., a user of a PCD 200 device running a web browser) can input a name and/or a location where to save a downloadable media content file in a local directory (e.g., in a directory of a PCD 200, such as a Media Content Repository 214); a “File Type” selection area allowing a user to select a file type to save a downloadable media content as; a “Delivery Deadline” selection allowing a user to select a maximum duration over which a media content download should take place; and a delivery priority selection, allowing a user to select a priority level for a media content download (e.g., an order selection for multiple, concurrent downloads).

In accordance with an embodiment, the following scenario would be facilitated by the present invention. A user of a PCD 200 may utilize their web browser to view a MCP web site 1000 and order a burdensome video file to be downloaded using the user's broadband internet service. From the user's perspective, the media content file may be delivered transparently without further interaction from the user and without tying up the user's internet service. The video file may then be advantageously delivered using surplus network bandwidth capacity in the access provider's network, which supplies the broadband internet service to the user. The media content order may subsequently be split into two parts, (1) from the MCP 300 to an APD 400, such as a Delivery Proxy Server (DPS) (this portion of the coordinated delivery may occur in real-time, as an unprotected, continuous data transfer), and (2) from the APD/DPS 400 to the user of the PCD 200, utilizing a managed content delivery whenever surplus network capacity is available. Delivery from the MCP 300 to the APD/DPS 400 may use ordinary network communications protocols (e.g., ftp, http, https, smtp, pop3, imap, p2p, etc.) and may not require any specialized infrastructure.

A related scenario may occur when the sender is cooperating with the receiving user's access network provider. In that case, the sender (e.g., MCP 300) operates compatible application software where packets are delivered to the receiver (e.g., PCD 200) whenever end-to-end surplus network capacity is available. In this scenario, the network access provider is not actively involved in setting up or operating the media content file delivery session, nor is an APD/DPS 400 required.

In accordance with an embodiment, the following scenario would be facilitated by the present invention. A user of a PCD 200 returns from their vacation with a large number of photographs and videos to share with friends. After editing the media content with various photo and video editing software, resident on their PCD 200, the user emails the media content to a list of selected friends. From the user's point of view, the content may be delivered quickly and transparently without tying up their internet service or causing congestion in the user's access network. The media content order may subsequently be split into two parts, (1) from the user's PCD 200 to the APD/DPS 400 via managed content delivery (this portion of the coordinated delivery may be protected by transferring media content during periods of surplus bandwidth), and (2) from the APD/DPS 400 to the intended list of friends. Delivery from the APD/DPS 400 to the intended destinations may use ordinary network communications protocols (e.g., pop3, imap, etc.) and may not require any special infrastructure.

A related scenario may occur when the sender's chosen destination (e.g., a remote email server) operates cooperating application software that allows a user's media content data file to be delivered end-to-end using surplus network capacity. In that case, the sending user's network access provider is not actively involved in setting up or operating the file delivery session, nor is an APD/DPS 400 required.

In an embodiment, the invention may operate by the transfer originator or originator's application (e.g., such as a MTM 210) detecting a burdensome media content file during a delivery session setup. After the burdensome media content file is detected, a special managed file delivery mode may be initiated, where the media content may be delivered to or from an intermediary APD/DPS 400, and then to end device using surplus network capacity that avoids congesting the delivery networks during peak operating periods. In accordance with various embodiments, the media content detection/determination and coordinated delivery processes of the present invention may be deployed by a sender, a sender's access provider, a receiver's access provider, a receiver, or combinations thereof.

In an embodiment, in order to detect when a burdensome media content file will be transferred, the originating user's application, can autonomously inspect session setup messages to learn Meta-Data details such as the expected transfer protocol (e.g., ftp, http, https, smtp, pop3, imap, p2p, etc.), size of the file (e.g. ftp SIZE command, http CONTENT-LENGTH command), the far-end server domain name, etc. Once a large file delivery request is detected the user's application can automatically trigger a managed file delivery session, or ask the user for permission to start a managed file delivery session. Alternatively, the user can manually trigger a managed file delivery session (e.g. by right-clicking on a web link and selecting a menu option, See e.g., FIGS. 10 and 11). In any case, a session Meta-Data may be sent to an APD/DPS 400, which then sets up a managed delivery session between the user and the APD/DPS 400. The APD/DPS's 400 other primary function is to act on behalf of a user of a PCD 200, to transfer media content to or from the remote end. This transfer proceeds according to standard data protocols that the originating user would have ordinarily used to transfer the content (e.g., ftp, http, https, smtp, pop3, imap, p2p, etc.). The APD/DPS 400 may use the session Meta-Data to learn the details of the transfer session.

An advantage of using a APD/DPS 400 is that it can be operated by an access provider to protect their network from congestion when it is part of a larger WAN, such as the Internet, without requiring cooperation from networks beyond the access provider's borders. Alternatively, if the far end of a data connection supports the same delivery management protocols as the near end, then an end-to-end file delivery session can be established without resorting to using an intermediary APD/DPS 400. Under this scenario, both endpoints may agree to use the same delivery management protocol.

In an embodiment, sending and receiving pairs (e.g., server and client) of software modules may operate in concert to sense when surplus network capacity (e.g., free bandwidth) exists in their connecting networks. The pairs may then regulate data throughput between them in order to not exceed that capacity.

In accordance with an embodiment of the present invention, a generic network architecture may exist where a sending node and receiving node may be interconnected by a series of networks and network devices. Various end devices are assumed to be connected via a local area network (LAN) and a gateway device. In some implementations the end node, LAN, and gateway may be part of the same physical unit. In other cases the interconnecting networks may be collapsed into a single access network. Examples of access network types may include fiber-optic, DSL, Cable, wireless, and wired data communications networks operated by network access providers.

In an embodiment, a file may be sent from a sending node to a receiving node, and either endpoint may be the originating trigger for the media file transfer. For example, in a download scenario, the originating node may request a media file from the sending node, which initiates the transfer to the receiving node. In an upload scenario, the originating node may also be the sending node that contacts the receiving node to begin transferring the file.

In an embodiment, a media content download session may be originated by the receiving node. The process may begin with a user who selects a file for a managed download. Examples of this step may include a user operating a standard web browser with a managed file download plug-in software module (See e.g., FIGS. 10 and 11). The user may browse to a media content provider's web page and trigger a download request (e.g., by clicking on a link or icon). The browser plug-in may then detect and intercept the download request by monitoring a user interface of the browser and then querying the remote web server as to the file size, length, type, location of content source, number of network hops to content sources, content source network address, user authentication/authorization credentials or available transfer protocol (e.g., ftp, http, https, smtp, pop3, imap, p2p, etc.) of the download file. The browser plug-in may compare the file size against a configured setting and type of network attachment to determine whether the file is suitably large (burdensome) for managed delivery. If it is not large enough to qualify for a managed delivery, the plug-in may allow the download to proceed using ordinary delivery protocols and methods (e.g., ftp, http, https, smtp, pop3, imap, p2p, etc.). However, if the file is suitably large for a managed delivery, the plug-in alerts a download client (a component of a MTM) with a message containing the proposed download Meta-Data.

In accordance with another embodiment, a user may manually trigger a managed download. For example, a user may browse to a content provider's website (See e.g., FIGS. 10 and 11) and right-click on a link or icon representing downloadable media content. The browser plug-in may present the user with a drop-down menu list that includes the option for a managed file download, which the user can select. As in the first example, the plug-in may alert a MTM/DLC (Media Transfer Manger having Download Client functionality) with a message containing the proposed download Meta-Data. In an embodiment, the MTM/DLC may collect the Meta-Data from the plug-in and then format and send a message to an APD 400. The contents of the message may include the download session Meta-Data.

The APD/DPS 400 may be located at various places in the networks connecting a user to a MCP 300. For example, an access provider could locate the APD/DPS 400 at its border with an Internet backbone network. Other locations are possible depending on business peering relationships of the network operators. The APD/DPS 400 may use download session Meta-Data to set up a proxy session on behalf of a user with the MCP's server (sending node). In some cases this might require relaying file access authorization messages (e.g. username, password, authentication challenges, etc.) to the user. Examples of this step may include an ftp download request for a file which the APD/DPS 400 would format and proxy on behalf of the user but for delivery to the receiving device. Another example may be a P2P download session. In an embodiment, the presence of the APD/DPS 400 could serve as the point for concurrent uplink trades with remote peers (commonly required by P2P transfer protocols as a condition for downloading) which would free the requesting download end node from congesting their uplink. The APD/DPS 400 may also use the session Meta-Data to set up a managed delivery session with the user's MTM/DLC in response to the Meta-Data message sent to it. The MCP 300 begins to transfer a file to the APD/DPS 400, which buffers it as it is received. Part of this process may include partitioning and formatting of the received file for managed file delivery. Concurrently, or at a later time, the DPS may begin transfer of the buffered file to the user's MTM/DLC according to the availability and capacity of the network or networks between the APD/DPS 400 and MTM/DLC. In effect, the APD/DPS 400 involvement in the file transfer avoids congesting the networks in the path between the APD/DPS 400 and MTM/DLC. The path between the MCP 300 and the APD/DPS 400 may not be protected other than by standard transport flow controls, but it also does not have to be aware of the details of the managed file transfer protocol. In an embodiment, once a data file is delivered to the MTM/DLC, the data may be presented to the user utilizing one or more ordinary application user interfaces. Examples of this step may include a browser pop-up window allowing the user to save the file (alternatively it could be auto-saved to a pre-selected location).

In an embodiment, an upload session originated by a sending node may be initiated by a user who selects a file for managed upload. In an embodiment, a user may operate an email client application to create an email and attach a burdensome media content file for sending. The user may compose the letter, attach the media content file, and press send to trigger delivery of the email to a remote mail server (optionally represented by any of remote server devices 104a-c). An email add-on module may monitor the application user interface to automatically detect the send event. The file size may be determined from the client and it may then be determined whether the file size exceeds a predetermined file size threshold. If it does not exceed the threshold, the email continues to transfer using ordinary protocols and procedures (e.g., pop3, imap). If the file is large enough to exceed the threshold, the add-on sends a message to an MTM/ULC (Media Transfer Manger including Uplink Client functionality) containing the uplink Meta-Data concerning the proposed email delivery. In another embodiment, a user manually chooses the email delivery method. In this case the user could select a send option for delivering the email via a managed file delivery. As before, an email add-on module may alert the MTM/ULC with the Meta-Data for the uplink session.

As with the downlink scenario, the MTM/ULC may be collocated on the endpoint device (e.g., on a laptop computer 124 of FIG. 1). However, other possibilities may be feasible. In an embodiment, the MTM/ULC may be located on another device sharing a LAN with the user's device. As with the downlink case, one possibility would be to operate a MTM/ULC on the gateway device. The MTM/ULC may collect the Meta-Data from the add-on application and formats it to send in a message to an APD/DPS 400. The message may include details about the upload such as the length of the file, remote server information, email protocol, etc.

In an embodiment, the APD/DPS 400 could be located at various places in the networks connecting the user to the MCP 300. For example, an access provider could place the APD/DPS 400 at its border with an Internet backbone network. Other locations may be possible depending on business peering relationships of the network operators. The APD/DPS 400 may use the upload session Meta-Data to set up a proxy session on behalf of the user with the MCP's server (receiving node). In some cases, this might require relaying file access authorization messages (e.g. username, password, or authentication challenges) to the user. Examples of this step may include a pop3 email send request for a file which the APD/DPS 400 would format and proxy on behalf of the user, but for delivery from the APD/DPS 400 to the destination email server.

The APD/DPS 400 may also use session Meta-Data to set up a managed delivery session with the user's MTM/ULC in response to the MTM/ULC Meta-Data message sent to it. The MTM/ULC may begin to transfer the file to the APD/DPS 400, according to the availability and capacity of the network or networks between them. The APD/DPS 400 may buffer the file as it is received. Concurrently, or at a later time, the APD/DPS 400 may begin transfer of the buffered file to the receiving node using ordinary file transfer protocols associated with the proxy session. The APD/DPS 400 involvement in the file transfer can avoid congesting the networks in the path between the MTM/ULC and APD/DPS 400, for example the user's access provider network. In an embodiment, the path between the APD/DPS 400 and destination is not protected, but it also does not have to be aware of the details of the managed file transfer protocol.

While several embodiments of the present invention have been illustrated and described herein, many changes can be made without departing from the spirit and scope of the invention. Accordingly, the scope of the invention is not limited by any disclosed embodiment. Instead, the scope of the invention should be 920 determined from the appended claims that follow.

We claim:

1. A networked computing system for detecting and coordinating the distribution of burdensome media content, the networked computing system comprising:
a first computing device;
a second computing device; and
a data communications network facilitating data communications amongst all computing devices within the networked computing system,
wherein the first computing device generates a data transfer request indicating a media content to be transferred, and in response to the data transfer request, an automatic determination is made as to whether the media content is burdensome with respect to at least a portion of the data communications network pathway over which the media content is to be transferred and wherein media content determined to be burdensome is transferred over the data communications network during periods of surplus bandwidth.

2. The networked computing system of claim 1, further comprising a third computing device that acts as a relay between the first computing device and the second computing device, such that a burdensome media content is transferred to the third computing device before being forwarded to an end receiving device.

3. The networked computing system of claim 1, wherein the first computing device coordinates a download of the burdensome media content from at least the second computing device to the first computing device.

4. The networked computing system of claim 1, wherein the first computing device coordinates an upload of the burdensome media content from the first computing device to at least the second computing device.

5. The networked computing system of claim 1, wherein the automatic determination of whether the media content is burdensome further comprises an analysis of available network resources and an analysis of characteristics associated with the media content.

6. The networked computing system of claim 5, wherein the analysis of available network resources further comprises predicting available network bandwidth during distinct time periods based on past network performance.

7. The networked computing system of claim 5, wherein the analysis of the characteristics associated with the media content further comprises an analysis of the size and type of the media content to be transferred as well as available data transfer protocols.

8. A non-transitory computer-readable medium encoded with computer executable instructions, which when executed, performs a method comprising:
generating a data transfer request indicating a media content to be transferred, and automatically determining whether the media content is burdensome to at least a portion of a data communications network pathway over which the media content is to be transferred, in response to the data transfer request.

9. The non-transitory computer-readable medium of claim 8, wherein the method further comprises transferring a burdensome media content from a sending device to an intermediary relay device before being forwarded to a receiving device.

10. The non-transitory computer-readable medium of claim 8, wherein a receiving device coordinates a download of the burdensome media content from at least one sending device to the receiving device.

11. The non-transitory computer-readable medium of claim 8, wherein a sending device coordinates an upload of the burdensome media content from the sending device to at least one receiving device.

12. The non-transitory computer-readable medium of claim 8, wherein the automatic determination of whether the media content is burdensome further comprises an analysis of available network resources and an analysis of characteristics associated with the media content.

13. The non-transitory computer-readable medium of claim 12, wherein the analysis of available network resources further comprises predicting available network bandwidth during distinct time periods based on past network performance.

14. The non-transitory computer-readable medium of claim 12, wherein the analysis of the characteristics associated with the media content further comprises an analysis of the size and type of the media content to be transferred as well as available data transfer protocols.

15. A computer-implemented method comprising:
generating a data transfer request indicating a media content to be transferred, and automatically determining whether the media content is burdensome to at least a portion of a data communications network pathway over which the media content is to be transferred, in response to the data transfer request.

16. The computer-implemented method of claim 15, wherein the method further comprises transferring a burdensome media content from a sending device to an intermediary relay device before being forwarded to a receiving device.

17. The computer-implemented method of claim 15, wherein a receiving device coordinates a download of the burdensome media content from at least one sending device to the receiving device.

18. The computer-implemented method of claim 15, wherein a sending device coordinates an upload of the burdensome media content from the sending device to at least one receiving device.

19. The computer-implemented method of claim 15, wherein the automatic determination of whether the media content is burdensome further comprises an analysis of available network resources and an analysis of characteristics associated with the media content.

20. The computer-implemented method of claim 19, wherein the analysis of available network resources further comprises predicting available network bandwidth during distinct time periods based on past network performance and the analysis of the characteristics associated with the media content further comprises an analysis of the size and type of the media content to be transferred as well as available data transfer protocols.
